(19) United States
(12) Patent Application Publication
(10) Pub. No.: US 2018/0124060 A1
(43) Pub. Date: May 3, 2018

(54) METHOD TO NOTIFY ENTITIES TO PRESERVE PRIVACY AND TRACK COMPLIANCE

(71) Applicants: Mark Aram Dildilian, Lexington, KY (US); Ronald Charles Thorpe, San Antonio, TX (US)

(72) Inventors: Mark Aram Dildilian, Lexington, KY (US); Ronald Charles Thorpe, San Antonio, TX (US)

(21) Appl. No.: 15/798,869

(22) Filed: Oct. 31, 2017

Related U.S. Application Data
(60) Provisional application No. 62/415,259, filed on Oct. 31, 2016.

(51) Int. Cl. H04L 29/06

(52) U.S. Cl. CPC H04L 63/102

(57) ABSTRACT

A method for notifying entities to preserve privacy and track their compliance. The method embodies computing devices of users and a cloud service. The cloud service is adapted to aggregating computer device and user information, compliance information and associated purchases in creating privacy groups operatively associated with a predetermined entity or entities. The cloud service is also adapted to maintain and communicate volume-based notification of privacy request to the predetermined entities as well as report and track compliance and violations.

### CROSS-REFERENCE TO RELATED APPLICATION

This application claims the benefit of priority of U.S. provisional application No. 62/415,259, filed 31-Oct.-2016, the contents of which are herein incorporated by reference.

### BACKGROUND OF THE INVENTION

The present invention relates to online privacy and, more particularly, to a method for notifying entities to preserve privacy and track their compliance.

As the penetration of the Internet of Things increases, and as surveillance technology improves, many entities use facial recognition and/or location identification of a user's computing device to target messages to that user through the user's computing device or surrounding computing devices. An example would be in-store specific advertising based upon the individual's current and previous location. These entities also record this information for their future use and/or in conjunction with other organizations. One example would be identifying a person who has recently purchased a membership at a workout entity as they enter a grocery store for the purpose of sending them a text message on their personal device or even on a monitor in the store about a sale on organic food. Another example would be the same grocery store identifying the person via their physical characteristics, noting that that person has a loyalty card with the store, reviewing their past purchases and therefore targeting them for advertising either while they are in the store or based upon which aisles they traversed while they are in the store. Computer technology has made people's lives more convenient, but along with this convenience comes problems rooted therein, such as invasion of privacy, which specifically arises in the realm of computer networks.

As can be seen, there is a need for a computing implemented method to solve this privacy problem unique to the Internet of Things by enabling users to identify themselves as a member of a group that wants their privacy preserved by predetermined entity. The messages to said entity vary depending upon the size of the group. The entity would then know that 10, 100, 1000, 10000, etc. people want their privacy preserved. Also, individual users can identify entities' violations of their privacy or other members who are part of the group.

The problem is solved by the user executing a privacy application that indicates that they have joined a group that wants their privacy preserved by a specifically identified entity. If the user has not yet registered, their identifying physical features and contact information may be collected and stored. The privacy application then identifies the entity via GPS and/or data entry. A cloud-based service then registers this person as part of a group that wants to preserve their privacy at the identified entity. Depending upon the number of people registered for privacy at the identified entity (and their affiliated entities) a tiered email is selected to be sent to the identified entity which also includes the identifying characteristics of this specific individual or at least their computing device.

The end-user also has the ability to track the responsiveness of the targeted entity and inform other members of the group and the privacy application of any infractions of the requested privacy by the entity. All members of the group can use this information to decide if they will continue to support the entity. Since violations would be tracked, it also gives the individual the potential of being part of a class action if the entity routinely violates the request to preserve privacy.

### SUMMARY OF THE INVENTION

In one aspect of the present invention, method for notifying entities to preserve privacy and track their compliance includes aggregating user data from a plurality of computing devices in at least one of a plurality of privacy groups as a function of an operative association of each computing device to at least one of a plurality of entities; compiling a plurality of privacy requests as a function of the aggregated user data of each privacy group; and communicating at least one of the plurality of privacy requests to each entity operatively associated with each privacy group.

In another aspect of the present invention, the method for notifying entities to preserve privacy and track their compliance includes aggregating user data from a plurality of computing devices in at least one of a plurality of privacy groups as a function of an operative association of each computing device to at least one of a plurality of entities, wherein the aggregated user data includes identifying information for each operatively associated computing device; compiling a plurality of privacy requests as a function of the aggregated user data of each privacy group; communicating at least one of the plurality of privacy requests to each entity operatively associated with each privacy group, wherein each privacy request comprises the number of computing devices operatively associated to said entity; compiling a plurality of violation notices as a function of a type and a frequency of unsolicited contact received by each computing device from each entity operatively associated therewith; communicating at least one of the plurality of violation notices to each entity engaging in said unsolicited contact; adding each communicated violation notice to said aggregated user data.

These and other features, aspects and advantages of the present invention will become better understood with reference to the following drawings, description and claims.

### BRIEF DESCRIPTION OF THE DRAWINGS

FIG. 1 is a flow chart view of an exemplary embodiment of the present invention; and

FIG. 2 is a schematic view of an exemplary embodiment of the present invention, demonstrating a user's application.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for notifying entities to preserve privacy and track their compliance. The method embodies computing devices of users and a cloud service. The cloud service is adapted to aggregating computer device and user information, compliance information and associated purchases in creating privacy groups operatively associated with a predetermined entity or entities. The cloud service is also adapted to maintain and communicate volume-based notification of privacy request to the predetermined entities as well as report and track compliance and violations.

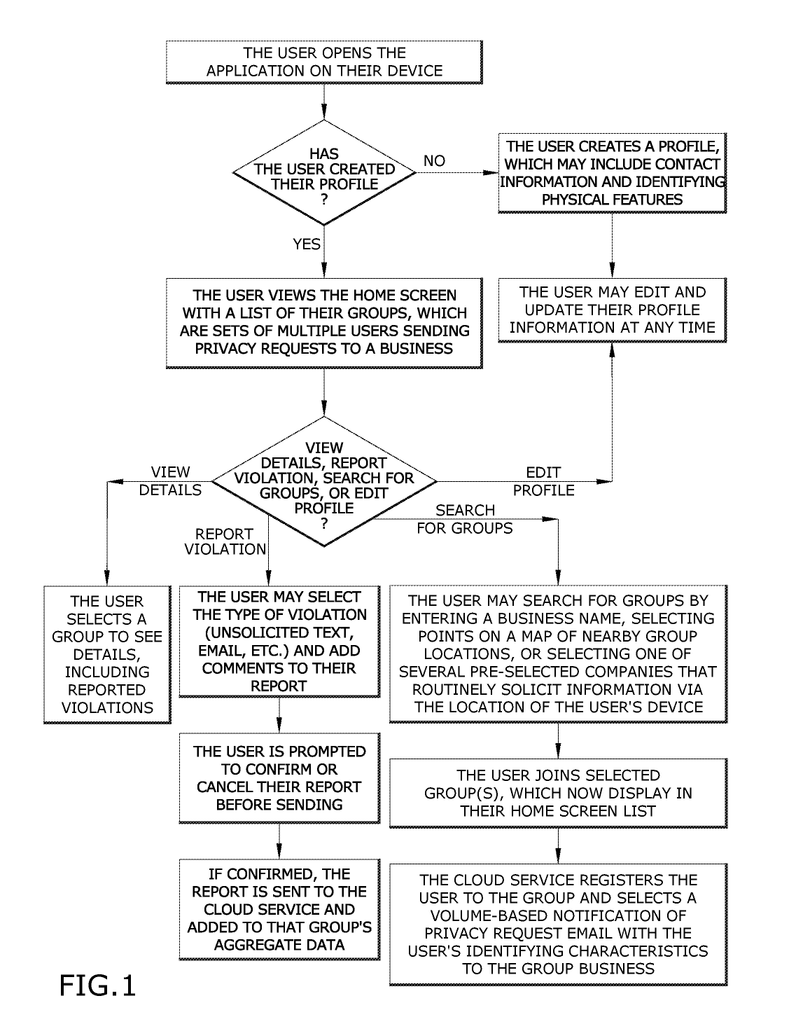

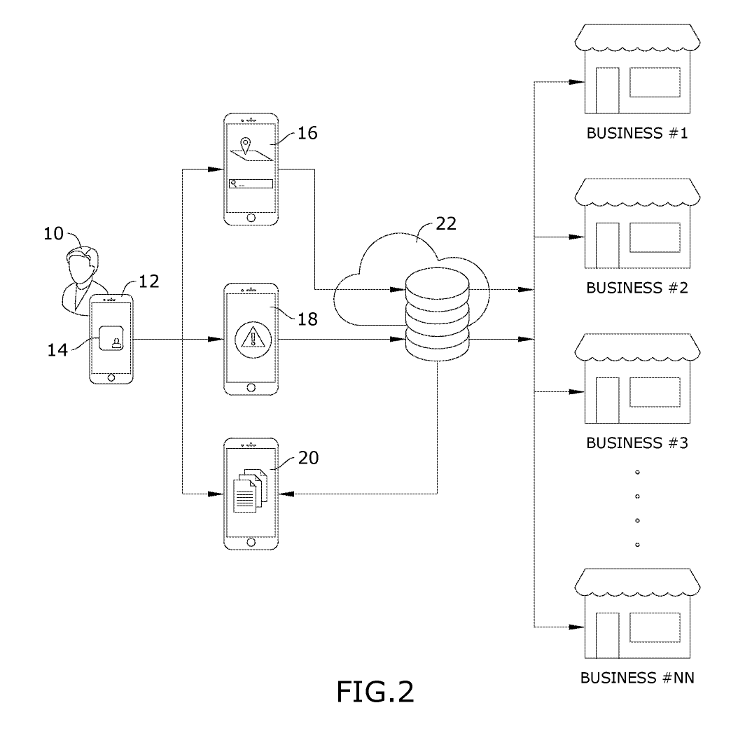

Referring to FIGS. 1 and 2, the present invention may include at least one computing device 12 with a user interface 11. The computing device 12 may include at least one processing unit and a form of memory including, and not limited to, a desktop, laptop, and smart device, such as, a tablet and smart phone. The computing device 12 may include a program product including a machine-readable program code for causing, when executed, the computing device 12 to perform steps. The program product may include software which may either be loaded onto the computing device 12 or accessed by the computing device 12. The loaded software may include a privacy software application 14 on the computing device, as illustrated in FIG. 1. The software may be accessed by the computing device 12 using a web browser. The computing device 12 may access the software via the web browser using the internet, extranet, intranet, host server, internet cloud and the like.

The present invention may provide a computer implemented privacy system embodying two major components: a computing device 12 of a user 10 and a cloud service 22. The computing device 12 component is typically mobile-based, enabling the user 10 to carry it around on their person. The software application 14 loaded on the computing device 12 is coupled to the computing device's user interface 11, GPS, data input, storage, camera, operating system payment capabilities, and cellular and/or network capabilities to communicate back and forth with the cloud-based component 22, exchanging data as necessary. The cloud-based component 22 exchanges information according to sets of rules via a computing environment, such as the Internet, back and forth with the computing device 12.

The cloud-based component 22 may provide sets of rules for aggregating all user information, complaint information and associated purchases in databases and creating privacy groups operatively associated with an entity or entities. Entities includes business, establishments, organizations, affiliates, partnerships, sole proprietorships, and the like. The privacy groups may provide parameters containing establishment name, alias names, contact information, privacy violation complaint volume, GPS locations and user account references that want their privacy protected at that entity and their affiliates. The cloud based component 22 may provide a set of rules for maintaining a separate list of base legal letters and volume variations to send to an entity when a user requests privacy from an entity. The specific letter sent via the email service/internet to the entity depends upon the volume of users requesting privacy from that entity and the current volume of complaints from the users regarding that entity. When notification is sent from the cloud-based component 22 to the entity, the cloud-based component 22 may communicate back to the computing device 12 to authorize a charge to the user.

The above-mentioned set of rules may provide logic gates including the software application 14 ability to take image of user and their personal information; the software application 14 ability to use GPS to determine location; the software application 14 ability to charge user; the software application 14 ability to communicate with the cloud based component/application 22; the cloud based component/application 22 ability to send information to targeted entities; the cloud based component/application 22 ability to decide which information to send to the entity based upon number of users registered; the cloud based component/application 22 ability to communicate with the software application 14; and the like.

The program product may provide native execution code on the computing device 12 combined with execution code located on a centralized server/cloud based component/application 22 designed to implement the product. The computing device 12 may primarily be used for GPS location determination, user face capture and user input purposes. The computing device 12 may also select general entities that target users 10 via GPS location of their computing devices 12. The cloud based component may include a centralized computing device 12 or server that is coupled to and maintains several databases to store user information, entity information, group information, violation information and legal documents. Therefore, the sets of rules may provide logic required to communicate with the native mobile computing devices 12, maintain all databases, send out notices and charge the users for use of the product. The centralized server/cloud based component 22 may also have an administrative function where users can be disabled.

Referring to FIG. 1, the present invention may be used as followings. The computer environment privacy system and sets of rules disclosed above may be provided. After the initial registration and user profile creation, which may include retrievable storage of the user's name, storage of information regarding the user's computing device 12, and optionally storage of their physical appearance, the user will subsequently be able to use their personal computing device 12 to notify entities that they do not want to be targeted for advertising purposes while in their affiliated entities or their visit and/or metadata tracked or stored to accommodate future advertising or solicitation efforts. This will be accomplished by the user entering an entity and pressing a control on their computing device 12 indicating that they do not want to be tracked. The software application 14/native code executing on their computing device 12 will communicate to the execution code on the cloud based component 22/centralized server which, based upon the number of users that have already joined the group wanting to preserve their privacy with this operative associated entity, will select a specific message communicating with the entity, possible via electronic email that this user is part of a group that does not want to be tracked for non-user initiated advertising purposes. The communication will also indicate that this request will remain in effect for all affiliations of this entity. Information included in the message will be the group size, user's name, address, and identifying information for all of the user's personal computing device 12 and optionally the user's physical identifying information.

If the user subsequently receives unsolicited contact from the entity, they will be able to report that violation via the application on their computing device 12. In certain embodiments, the present invention provides electronic representation of a report violation interface 18 on the user interface 11 of the computing device 12. A message may be sent to the entity notifying them of the violation and the relative score versus the number of users registered for that entity will be made known to other users. In certain embodiments, any specific user may only be able to report a violation once per entity.

Additional steps supported by the present invention may include the following. After opening the software application 14 on their computing device 12, the registered user 10 may edit and update their profile information. The user 10 may view the home screen on the user interface 11 of their computing device 12. The home screen may list affiliated groups, which are sets of multiple users sending privacy request to relevant, operatively associated entities. Through the user interface 11, the user 10 may view details, reports violations, and search for groups. In certain embodiments, the present invention provides electronic representation of the report violation interface 18, a search and join interface 16, a view group details interface 20, and the like on the user interface 11 of the computing device 12.

Through the view group details interface 20, for example, the user 10 may select a group to see relevant group details, including reported violations. Through the report violation interface 18, the user 10 may select the type of violation (unsolicited text, email, etc.) and add comments to their report. During this mode, the user 10 may be prompted to confirm or cancel their report before sending. If confirmed, the report is exported to the cloud service 22 and added to that group's aggregate data. Through the search and join interface 16, the user 10 may search for groups by entering an entity name, selecting points on a map of nearby group locations, or selecting one of several pre-selected companies that routinely solicit information via the location of the user's computing device 12. Then the user may join selected group(s), which not display in their home screen list. The cloud based service 22 registers the user 10 to the group and selects a volume-based notification of privacy request email with the user's identifying characteristics to the group entity.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of maintaining Internet privacy, comprising:
aggregating user data from a plurality of computing devices in at least one of a plurality of privacy groups as a function of an operative association of each computing device to at least one of a plurality of entities;
compiling a plurality of privacy requests as a function of the aggregated user data of each privacy group; and
communicating at least one of the plurality of privacy requests to each entity operatively associated with each privacy group.

2. The method of claim 1, wherein the aggregated user data comprises identifying information for each operatively associated computing device.

3. The method of claim 1, wherein each privacy request comprises the number of computing devices operatively associated to said entity.

4. The method of claim 1, further comprising:
compiling a plurality of violation notices as a function of a frequency of unsolicited contact received by each computing device from each entity operatively associated therewith; and
communicating at least one of the plurality of violation notices to each entity engaging in said unsolicited contact.

5. The method of claim 4, further comprising adding each communicated violation notice to said aggregated user data.

6. The method of claim 5, further comprising recompiling the plurality of privacy requests as a function of the aggregated user data of each privacy group.

7. The method of claim 4, further comprising compiling the plurality of violation notices as a function of a type of unsolicited contact received by each computing device from each entity operatively associated therewith.

8. A method of maintaining Internet privacy, comprising:
aggregating user data from a plurality of computing devices in at least one of a plurality of privacy groups as a function of an operative association of each computing device to at least one of a plurality of entities,
wherein the aggregated user data comprises identifying information for each operatively associated computing device;
compiling a plurality of privacy requests as a function of the aggregated user data of each privacy group;
communicating at least one of the plurality of privacy requests to each entity operatively associated with each privacy group,
wherein each privacy request comprises the number of computing devices operatively associated to said entity;
compiling a plurality of violation notices as a function of a type and a frequency of unsolicited contact received by each computing device from each entity operatively associated therewith;
communicating at least one of the plurality of violation notices to each entity engaging in said unsolicited contact;
adding each communicated violation notice to said aggregated user data.
